(19) United States
(12) Patent Application Publication
(10) Pub. No.: US 2025/0099978 A1
(43) Pub. Date: Mar. 27, 2025

(54) SEPARATION CHIP

(71) Applicant: SCREEN Holdings Co., Ltd., Kyoto (JP)

(72) Inventor: Katsuaki KAWARA, Kyoto-shi (JP)

(21) Appl. No.: 18/894,041

(22) Filed: Sep. 24, 2024

(30) Foreign Application Priority Data
Sep. 25, 2023 (JP) 2023-161225

(51) Int. Cl. B03C 5/02; B03C 5/00

(52) U.S. Cl. CPC B03C 5/026; B03C 5/005

(57) ABSTRACT

A separation chip includes a substrate, a plurality of electrodes disposed on one-side surface of the substrate, an insulation film covering at least a part of one-side surface of each of the electrodes, and an introduction-portion constituting member that is disposed on one side of the substrate, surrounds at least a portion of the electrodes, and defines an introduction portion into which a liquid containing dielectric particles is introduced. The one-side surface of each of the electrodes has a first region and a second region different from the first region. A thickness of the insulation film on the first region is smaller than a thickness of the insulation film on the second region.

### CROSS REFERENCE TO RELATED APPLICATIONS

This application claims priority based on Japanese Patent Application No. 2023-161225 filed on Sep. 25, 2023, the entire contents of which are incorporated herein by reference.

### BACKGROUND OF THE INVENTION

### 1. Field of the Invention

The present invention relates to a separation chip.

### 2. Description of the Related Art

Conventionally, a separation chip that separates specific cells from blood is known. Japanese Patent Application Publication No. 2017-134020 discloses a separation device including a replacement portion that extracts cells having a predetermined size or larger from blood, and a separation portion that separates, due to a dielectrophoresis force, cancer cells from a plurality of types of cells having passed through the replacement portion. The separation portion includes a channel through which a liquid containing cells flows and a pair of electrodes. When an AC (alternating current) voltage is applied between the pair of electrodes, a dielectrophoresis force acts on cancer cells passing in the channel, and the cancer cells are separated from the plurality of types of cells.

### SUMMARY OF THE INVENTION

In the separation chip as disclosed in Japanese Patent Application Publication No. 2017-134020, when the AC voltage is applied between the pair of electrodes, the dielectrophoresis force acts on dielectric particles in the channel, and the dielectric particles are attracted to the electrodes. Specifically, the dielectric particles are attracted to both end portions of upper surfaces of the adjacent electrodes. Therefore, it has been difficult to attract the dielectric particles to any desired position on the electrode.

The present invention has been made in view of the above problems, and one object thereof is to provide a separation chip capable of attracting dielectric particles to any desired position on an electrode.

A separation chip according to one aspect of the present invention includes a substrate, a plurality of electrodes, an insulation film, and an introduction-portion constituting member. The plurality of electrodes is disposed on one-side surface of the substrate. The insulation film covers at least a part of one-side surface of each of the electrodes. The introduction-portion constituting member is disposed on one side of the substrate. The introduction-portion constituting member surrounds at least a portion of the electrodes. The introduction-portion constituting member defines an introduction portion into which a liquid containing dielectric particles is introduced. The one-side surface of each of the electrodes has a first region and a second region different from the first region. A thickness of the insulation film on the first region is smaller than a thickness of the insulation film on the second region.

In a mode of the present invention, the insulation film may have an opening portion allowing the first region of each of the electrodes to communicate with or exposed to the introduction portion.

In a mode of the present invention, the opening portion may be formed at a position displaced with respect to a center of each of the electrodes in a width direction.

In a mode of the present invention, a step may be formed on the one-side surface of each of the electrodes.

In a mode of the present invention, each of the electrodes may have a concave shape or a recessed shape in a cross-sectional view.

In a mode of the present invention, each of the electrodes may include a pair of side surfaces disposed at end portions in a width direction, and a pair of connection surfaces. The second regions may be provided as a pair. Each of the pair of second regions may extend inward in the width direction from the pair of side surfaces. The first region may be disposed substantially parallel to the second regions between the pair of second regions. The pair of connection surfaces may allow the pair of second regions to be connected to the first region. The insulation film may not be formed on at least a part of the pair of connection surfaces.

In a mode of the present invention, the insulation film may include a silicon oxide film or a silicon nitride film.

In a mode of the present invention, the introduction portion may include a channel through which the liquid flows. The introduction-portion constituting member may define the channel.

In a mode of the present invention, the plurality of electrodes may include a first electrode and a second electrode which have comb shapes opposing each other. Each of the first electrode and the second electrode may have a plurality of teeth portions disposed in parallel to each other. One-side surface of each of the teeth portions may have the first region and the second region. The plurality of teeth portions may extend in an intersecting direction intersecting an extending direction of the channel.

The above-described or yet other objects, characteristics, and effects of the present invention will be clarified from the following description of example embodiments with reference to the accompanying drawings.

### BRIEF DESCRIPTION OF THE DRAWINGS

FIG. 1 is a plan view schematically showing a structure of a dielectrophoresis apparatus including a separation chip according to an example embodiment of the present invention.

FIG. 2 is an enlarged cross-sectional view schematically showing a cross-sectional structure of the separation chip of the example embodiment.

FIG. 3 is an enlarged cross-sectional view schematically showing a structure around an electrode.

FIG. 4 is an enlarged cross-sectional view schematically showing a structure of a comparative separation chip.

FIG. 5 is an enlarged cross-sectional view schematically showing a structure of the separation chip of the example embodiment.

FIG. 6 is a flowchart of a method for manufacturing the separation chip of the example embodiment.

FIG. 7 is an enlarged cross-sectional view for explaining the method for manufacturing the separation chip of the example embodiment.

FIG. 8 is an enlarged cross-sectional view for explaining the method for manufacturing the separation chip of the example embodiment.

FIG. 9 is an enlarged cross-sectional view schematically showing a structure of a separation chip according to a first modified example.

FIG. 10 is an enlarged cross-sectional view schematically showing a structure of a separation chip according to a second modified example.

FIG. 11 is an enlarged cross-sectional view schematically showing a structure of a separation chip according to a third modified example.

FIG. 12 is an enlarged cross-sectional view schematically showing a structure of a separation chip according to a fourth modified example.

FIG. 13 is an enlarged cross-sectional view schematically showing a structure of a separation chip according to a fifth modified example.

FIG. 14 is a plan view schematically showing a structure of a separation chip according to a sixth modified example.

FIG. 15 is a plan view schematically showing a structure of a separation chip according to a seventh modified example.

### DETAILED DESCRIPTION OF THE EXAMPLE EMBODIMENTS

Hereinafter, an example embodiment of the present invention will be described with reference to the drawings. It is noted that in the drawings, the same or corresponding portions will be given the same reference signs and will not be repeatedly described.

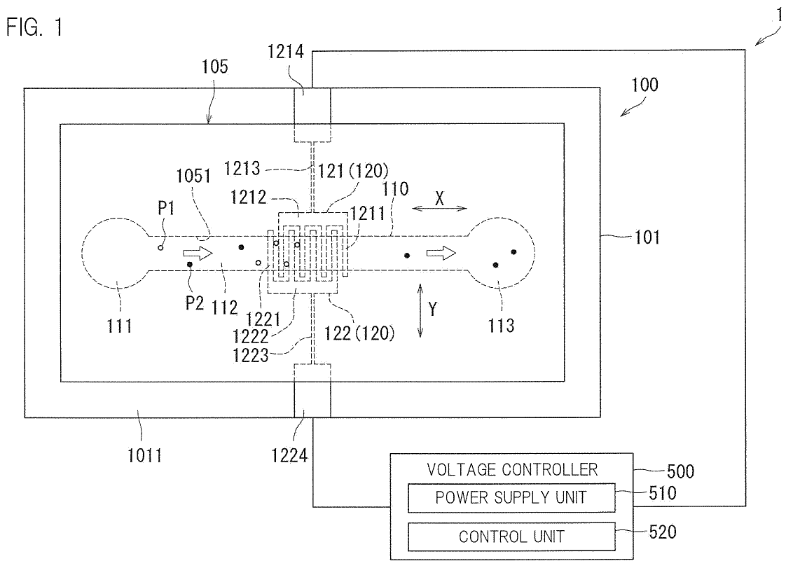

With reference to FIGS. 1 to 8, a dielectrophoresis apparatus 1 including a separation chip 100 according to the example embodiment of the present invention will be described. FIG. 1 is a plan view schematically showing a structure of the dielectrophoresis apparatus 1 including the separation chip 100 according to the example embodiment of the present invention.

As illustrated in FIG. 1, the dielectrophoresis apparatus 1 according to the example embodiment of the present invention includes the separation chip 100 and a voltage controller 500. The dielectrophoresis apparatus 1 causes a dielectrophoresis force to act on dielectric particles P1 contained in a sample liquid, thereby separating the dielectric particles P1 from other components P2 and collecting the dielectric particles P1. The sample liquid is not particularly limited, and is, for example, blood. The dielectric particles P1 are not particularly limited, and are, for example, cells, proteins, nucleic acids, or microorganisms. The cells are, for example, cancer cells. Also, the sample liquid may be seawater, physiological saline, pure water, or a chemical. The other components P2 are, for example, dielectric particles of a type different from that of the dielectric particles P1 or non-dielectric particles. As an example, the sample liquid is blood, the dielectric particles P1 are cancer cells, and the other components P2 are white blood cells. It is noted that the sample liquid is an example of the “liquid” of the present invention.

The separation chip 100 causes a dielectrophoresis force to act on the dielectric particles P1 contained in the sample liquid, thereby separating the dielectric particles P1 from the other components P2 and collecting the dielectric particles P1. A diameter of the dielectric particles P1 is, for example, several micrometers (μm) or larger and tens of micrometers (μm) or smaller.

The separation chip 100 includes a substrate 101, a channel 110, and an electrode 120. The channel 110 includes a supply portion 111, a separation channel 112, and a collection portion 113. A sample liquid is introduced into the supply portion 111. The supply portion 111 has, for example, an opening. The supply portion 111 is connected to, for example, a supply source of the sample liquid with a tube. It is noted that the channel 110 is an example of an “introduction portion” of the present invention.

The separation channel 112 connects the supply portion 111 and the collection portion 113 to each other. The sample liquid introduced into the supply portion 111 flows through the separation channel 112 toward the collection portion 113. The collection portion 113 collects the sample liquid that has passed through the separation channel 112. The collection portion 113 may have, for example, an opening. For example, the collection portion 113 may supply the sample liquid to the outside. It is noted that, in the present example embodiment, as will be described below, the collection portion 113 collects the sample liquid from which the dielectric particles P1 have been separated or removed.

The separation chip 100 includes a channel cover 105. The channel cover 105 is disposed over the substrate 101. The channel cover 105 has an area smaller than that of the substrate 101. That is, the channel cover 105 is disposed over a part of substrate 101. The channel cover 105 has a concave portion constituting the channel 110. The substrate 101 and the channel cover 105 define the channel 110. It is noted that the channel cover 105 is an example of an “introduction-portion constituting member” of the present invention.

The electrode 120 is formed of a conductive metal. It is noted that, in the present example embodiment, the metal is a conceptual material including an alloy. The electrode 120 is disposed at least in the separation channel 112. In other words, the electrode 120 overlaps at least the separation channel 112. The electrode 120 includes a first electrode 121 and a second electrode 122. The first electrode 121 and the second electrode 122 have, for example, comb shapes opposing each other. It is noted that the first electrode 121 and the second electrode 122 may not necessarily have comb shapes.

The first electrode 121 includes a plurality of teeth portions 1211, a first connection portion 1212, a second connection portion 1213, and a pad portion 1214.

Each of the teeth portions 1211 extends substantially linearly. The plurality of teeth portions 1211 are disposed substantially parallel to each other. Also, the plurality of teeth portions 1211 extend in a second direction Y intersecting a first direction X in which the channel 110 extends. In the present example embodiment, the second direction Y is substantially orthogonal to the first direction X. That is, in the present example embodiment, the teeth portions 1211 are substantially orthogonal to the channel 110. The first connection portion 1212 connects the plurality of teeth portions 1211 to each other. The plurality of teeth portions 1211 and the first connection portion 1212 form a comb shape. For example, the plurality of teeth portions 1211 are disposed across the separation channel 112 in a plan view. The first connection portion 1212 is disposed outside the separation channel 112 in a plan view. The plurality of teeth portions 1211 and the first connection portion 1212 are covered with the channel cover 105.

The second connection portion 1213 connects the first connection portion 1212 and the pad portion 1214 to each other. At least a part of the second connection portion 1213 is covered with the channel cover 105. At least a part of the pad portion 1214 is disposed outside the channel cover 105 in a plan view. In the present example embodiment, the second connection portion 1213 is covered with the channel cover 105. A part of the pad portion 1214 is disposed outside the channel cover 105 in a plan view. As described above, since at least a part of the pad portion 1214 is not covered by the channel cover 105, the pad portion 1214 can be easily connected electrically to the voltage controller 500.

The second electrode 122 includes a plurality of teeth portions 1221, a first connection portion 1222, a second connection portion 1223, and a pad portion 1224.

Each of portions the teeth 1221 extends substantially linearly. The plurality of teeth portions 1221 are disposed substantially parallel to each other. Also, the plurality of teeth portions 1221 are disposed substantially parallel to the plurality of teeth portions 1211. The first connection portion 1222 connects the plurality of teeth portions 1221 to each other. The plurality of teeth portions 1221 and the first connection portion 1222 form a comb shape. For example, the plurality of teeth portions 1221 are disposed across the separation channel 112 in a plan view. The first connection portion 1222 is disposed outside the separation channel 112 in a plan view. The plurality of teeth portions 1221 and the first connection portion 1222 are covered with the channel cover 105.

The second connection portion 1223 connects the first connection portion 1222 and the pad portion 1224 to each other. At least a part of the second connection portion 1223 is covered with the channel cover 105. At least a part of the pad portion 1224 is disposed outside the channel cover 105 in a plan view. In the present example embodiment, the second connection portion 1223 is covered with the channel cover 105. A part of the pad portion 1224 is disposed outside the channel cover 105 in a plan view. As described above, since at least a part of the pad portion 1224 is not covered by the channel cover 105, the pad portion 1224 can be easily connected electrically to the voltage controller 500.

The voltage controller 500 is electrically connected to both the pad portion 1214 and the pad portion 1224. The voltage controller 500 applies AC voltages corresponding to the type of dielectric particles P1 to the first electrode 121 and the second electrode 122 through the pad portion 1214 and the pad portion 1224. The AC voltage corresponding to the type of dielectric particles P1 is, for example, a frequency that generates an electric field that causes a dielectrophoresis force (attracting force) to specifically act on the dielectric particles P1, and a voltage having a magnitude to the extent that the dielectric particles P1 are not destroyed.

Specifically, the frequency of the AC voltage is set such that a positive dielectrophoresis force (attractive force) acts on the dielectric particles P1 due to the electric field between the first electrode 121 and the second electrode 122. Hence, the positive dielectrophoresis force acts on the dielectric particles P1, and the dielectric particles P1 are attracted to the electrode 120 (the first electrode 121 and the second electrode 122). On the other hand, the frequency of the AC voltage is set such that the dielectrophoresis force does not act or hardly acts on the other components P2. Hence, the other components P2 pass through the separation channel 112 and are collected in the collection portion 113.

The voltage controller 500 will be further described with reference to FIG. 1. The voltage controller 500 includes a power supply unit 510 and a control unit 520.

The control unit 520 controls the power supply unit 510. The control unit 520 includes, for example, a processor and a storage device. The processor is, for example, a central processing unit (CPU) or a micro processing unit (MPU). The storage device stores data and a computer program. The storage device includes a main storage device such as a semiconductor memory and an auxiliary storage device such as a semiconductor memory, a solid state drive, and/or a hard disk drive. The storage device may include removable media. The storage device is an example of a non-transitory computer readable storage medium.

The power supply unit 510 generates AC voltages corresponding to the dielectric particles P1 which is separation targets. The power supply unit 510 applies AC voltages to the first electrode 121 and the second electrode 122 through the pad portion 1214 and the pad portion 1224. The power supply unit 510 is, for example, a signal generator such as a function generator.

The AC voltages corresponding to the dielectric particles P1 are applied to the first electrode 121 and the second electrode 122 by the power supply unit 510, and thereby the dielectrophoresis force (attracting force) acts on the dielectric particles P1. Consequently, the dielectric particles P1 are attracted to the electrode 120, and the dielectric particles P1 are separated from the other components P2. In the present example embodiment, the dielectric particles P1 are captured by the electrode 120, and the other components P2 pass through the separation channel 112 and are collected in the collection portion 113.

It is noted that the voltage controller 500 may have a function of measuring electrical characteristics (impedance or the like) between the first electrode 121 and the second electrode 122. The voltage controller 500 may include, for example, a source measure unit.

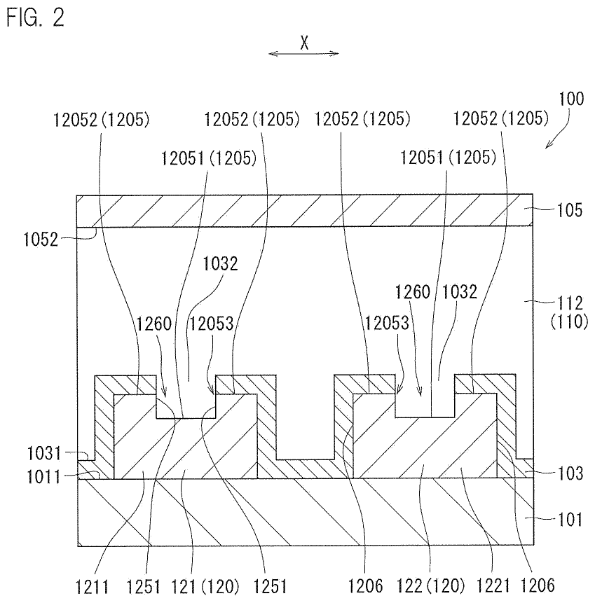

Next, a structure of the separation chip 100 will be further described with reference to FIG. 2. FIG. 2 is an enlarged cross-sectional view schematically showing a cross-sectional structure of the separation chip 100 of the present example embodiment.

As illustrated in FIG. 2, the separation chip 100 includes an insulation film 103 in addition to the substrate 101, the electrode 120, and the channel cover 105. The substrate 101 is, for example, a glass substrate. The material of the substrate 101 is, for example, quartz glass. However, the material of the substrate 101 is not limited to quartz glass. The substrate 101 has, for example, a substantially rectangular flat plate shape. However, the shape of the substrate 101 is not limited to the flat plate shape.

The electrode 120 is disposed on one-side surface 1011 of the substrate 101. A material of the electrode 120 is, for example, a metal such as aluminum, copper, and/or titanium. However, the material of the electrode 120 may be a metal other than aluminum, copper, and/or titanium. For example, the material of the electrode 120 may be a metal such as indium, tin, molybdenum, silver, chromium, tantalum, and/or silicon. Also, the material of the electrode 120 may be other than metal, and may include, for example, an oxide such as a metal oxide, or a semiconductor. Also, a front surface of the electrode 120 may be oxidized. Also, the electrode 120 may be formed of, for example, indium tin oxide (ITO). It is noted that the material of the electrode 120 is not particularly limited as long as the electrode 120 has conductivity.

The insulation film 103 covers at least a part of one-side surface 1205 of the electrode 120. The one-side surface 1205 of the electrode 120 is a surface on one side of the electrode 120 (a side opposite to the substrate 101). In the present example embodiment, the one-side surface 1205 of the electrode 120 is a surface that can be seen when the electrode 120 is viewed from the channel 110 side. Also, in the present example embodiment, the one-side surface 1205 of the electrode 120 is a surface substantially parallel to the one-side surface 1011 of the substrate 101. The insulation film 103 covers a portion of the one-side surface 1011 of the substrate 101, where the electrode 120 is not disposed, and at least a part of the electrode 120. It is noted that the insulation film 103 does not cover at least a portion of the pad portions 1214 and 1224 which is connected to the voltage controller 500. Also, the insulation film 103 also covers a side surface 1206 of the electrode 120.

The insulation film 103 has an insulating property. A material of the insulation film 103 is, for example, an oxide film such as a silicon oxide film, a nitride film such as a silicon nitride film, or a resin. In the present example embodiment, the insulation film 103 is a silicon oxide film. Also, a thickness and the material of the insulation film 103 affect the electric field formed by the electrode 120. That is, it is also possible to control the electric field formed by the electrode 120 depending on the thickness and the material of the insulation film 103. It is noted that the insulation film 103 also functions as a protective film that prevents an electrochemical reaction from occurring between the electrode 120 and the sample liquid.

Here, in the present example embodiment, the one-side surface 1205 of the electrode 120 has a first region 12051 and a second region 12052 different from the first region 12051. Specifically, the electrode 120 has a pair of side surfaces 1206 disposed at end portions in a width direction (the first direction X) and the one-side surface 1205 disposed substantially parallel to the one-side surface 1011 of the substrate 101. Hereinafter, a direction (here, the first direction X) intersecting an extending direction of the electrode 120 (the second direction Y) may be referred to as the width direction.

The one-side surface 1205 is connected to the pair of side surfaces 1206. The one-side surface 1205 has the first region 12051 positioned at the center in the width direction and a pair of second regions 12052 disposed outward in the width direction with respect to the first region 12051. The first region 12051 and the second region 12052 are formed on the one-side surfaces 1205 of the teeth portion 1211 and the teeth portion 1221. In other words, the one-side surfaces 1205 of the teeth portion 1211 and the teeth portion 1221 have the first region 12051 and the second region 12052.

In the present example embodiment, a step 12053 is formed on the one-side surface 1205 of the electrode 120. Also, in the present example embodiment, the electrode 120 has a concave shape or a recessed shape in a cross-sectional view. Specifically, each of the pair of second regions 12052 extends inward in the width direction from the pair of side surfaces 1206. The first region 12051 is disposed substantially parallel to the second regions 12052 between the pair of second regions 12052. The first region 12051 is disposed at a position closer to the substrate 101 than the pair of second regions 12052 are. The electrode 120 has a pair of connection surfaces 1251, and the pair of connection surfaces 1251 connects the pair of second regions 12052 and the first region 12051 to each other. A concave portion 1260 (or a recess portion) is formed in the electrode 120 by the first region 12051 and the pair of connection surfaces 1251.

The insulation film 103 covers at least a part of the one-side surface 1205 of the electrode 120. In the present example embodiment, a thickness of the insulation film 103 on the first region 12051 of the electrode 120 is smaller than a thickness of the insulation film 103 on the second region 12052 of the electrode 120. It is noted that, in the present example embodiment, the “thickness of the insulation film 103 on the first region 12051” indicates that the thickness of the insulation film 103 is 0 in a case where the insulation film 103 is not formed on the first region 12051.

Specifically, the insulation film 103 has an opening portion 1032 that allows the first region 12051 of the electrode 120 to communicate with or exposed to the channel 110. That is, in the present example embodiment, the insulation film 103 is not formed on the first region 12051. The opening portion 1032 is positioned on the first region 12051 and penetrates the insulation film 103.

Also, the insulation film 103 is not formed on at least a part of the connection surface 1251. That is, at least the part of the connection surface 1251 communicates with or exposed to the channel 110 without the insulation film 103 interposed therebetween. In the present example embodiment, the insulation film 103 is not formed on the connection surface 1251.

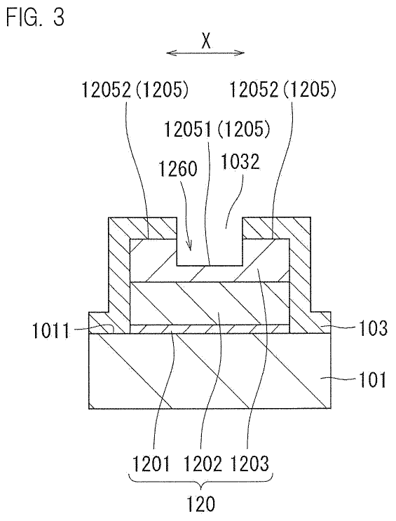

Next, a structure of the electrode 120 will be further described with reference to FIG. 3. FIG. 3 is an enlarged cross-sectional view schematically showing the structure around the electrode 120. As illustrated in FIG. 3, in the present example embodiment, the electrode 120 includes a first layer 1201, a second layer 1202, and a third layer 1203.

The first layer 1201 is disposed on the one-side surface 1011 of the substrate 101. The first layer 1201 is not particularly limited, and preferably includes, for example, a metal having good adhesion to the substrate 101. Also, the first layer 1201 preferably includes, for example, a metal that can prevent the second layer 1202 from diffusing into the substrate 101. In the present example embodiment, the first layer 1201 contains, for example, titanium.

The second layer 1202 is disposed on the first layer 1201. The second layer 1202 is disposed on a surface of the first layer 1201 opposite to the substrate 101. The second layer 1202 is not particularly limited, and preferably includes, for example, a metal having low electric resistivity. The second layer 1202 preferably contains, for example, aluminum or copper. In the present example embodiment, the second layer 1202 contains, for example, aluminum.

The third layer 1203 is disposed on the second layer 1202. The third layer 1203 is disposed on a surface of the second layer 1202 opposite to the first layer 1201. The third layer 1203 is not particularly limited, and preferably contains a metal that is not dissolved or hardly dissolved in the sample liquid. In the present example embodiment, the third layer 1203 contains, for example, titanium.

Thicknesses of the first layer 1201, the second layer 1202, and the third layer 1203 are not particularly limited. The first layer 1201 has, for example, a thickness of several nanometers (nm) or larger and tens of nanometers (nm) or smaller. The second layer 1202 has, for example, a thickness larger than that of the first layer 1201. The second layer 1202 has, for example, a thickness of tens of nanometers (nm) or larger and hundreds of nanometers (nm) or smaller. The third layer 1203 has, for example, a thickness larger than that of the second layer 1202. The third layer 1203 has, for example, a thickness of tens of nanometers (nm) or larger and hundreds of nanometers (nm) or smaller. It is noted that a width of the electrode 120 is not particularly limited, and is, for example, 40 μm or larger and 300 μm or smaller. Also, a distance between the electrodes 120 in the width direction (here, the first direction X) is not particularly limited, and is, for example, 10 μm or larger and 50 μm or smaller. Also, the thickness of the insulation film 103 is not particularly limited, and is, for example, hundreds of nanometers (nm) or larger and thousands of nanometers (nm) or smaller.

In the present example embodiment, the concave portion 1260 is formed to a midway point in a depth of the third layer 1203. That is, the first region 12051 of the one-side surface 1205 defining the concave portion 1260 is positioned in the third layer 1203. Therefore, the second layer 1202 is not in contact with the sample liquid. Therefore, even in a case where the second layer 1202 is formed of a metal that dissolves in the sample liquid, it is possible to prevent the second layer 1202 from dissolving in the sample liquid. It is noted that, in a case where the second layer 1202 is formed of a metal that does not dissolve in the sample liquid, the concave portion 1260 may be formed in the second layer 1202.

As illustrated in FIG. 2, the channel cover 105 is disposed over one-side surface 1031 of the insulation film 103, for example. A part of the channel cover 105 may be disposed over the one-side surface 1011 of the substrate 101. The channel cover 105 covers one side of the electrode 120 and the insulation film 103 (opposite side to the substrate 101). Also, the channel cover 105 defines the channel 110. Specifically, the channel cover 105 includes a side wall 1051 (see FIG. 1) and a ceiling 1052. The side wall 1051 and the ceiling 1052 define the channel 110 in which the sample liquid flows. The side wall 1051 surrounds at least a part of the electrode 120 in a plan view.

A material of the channel cover 105 is not particularly limited, and is, for example, a silicone-based resin. In the present example embodiment, the material of the channel cover 105 is dimethylpolysiloxane (PDMS). In a case where the channel cover 105 is formed of PDMS, the channel cover 105 is firmly bonded between the insulation film 103 and the front surface of substrate 101 by performing plasma processing on the channel cover 105, the insulation film 103, and the front surfaces of substrate 101.

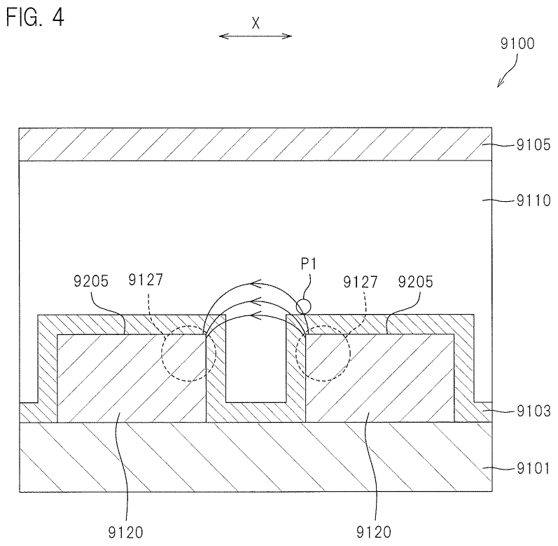

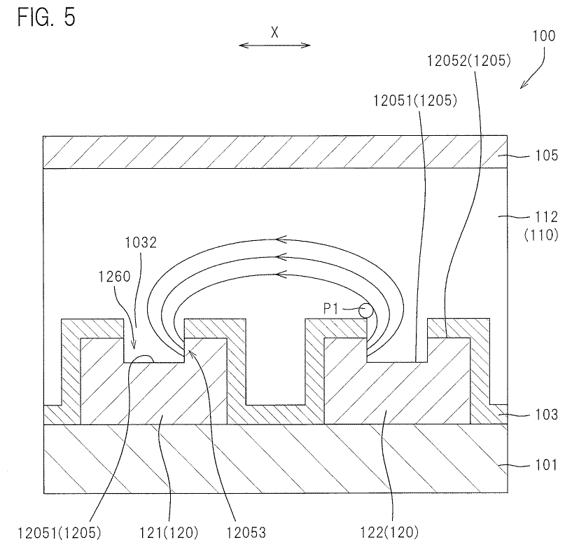

Next, effects achieved due to the separation chip 100 of the present example embodiment will be described with reference to FIGS. 4 and 5. Here, the effects achieved due to the separation chip 100 of the present example embodiment will be described as compared with a separation chip 9100 according to a comparative example. FIG. 4 is an enlarged cross-sectional view schematically showing a structure of the comparative separation chip 9100. FIG. 5 is an enlarged cross-sectional view schematically showing the structure of the separation chip 100 of the present example embodiment. It is noted that, in FIGS. 4 and 5, arrows straddling the electrodes schematically illustrate images of electric field lines for an easy understanding.

First, the comparative separation chip 9100 will be described with reference to FIG. 4. As illustrated in FIG. 4, the separation chip 9100 includes a substrate 9101, a channel 9110, an electrode 9120, an insulation film 9103, and a channel cover 9105. The electrode 9120 has a substantially rectangular shape in a cross-sectional view. That is, the step is not formed on one-side surface 9205 of the electrode 9120. Also, the insulation film 9103 has a substantially uniform thickness on the one-side surface 9205 of the electrode 9120. Also, the opening portion 1032 is not formed in the insulation film 9103.

In the comparative separation chip 9100, ∇E² (here, ∇E represents a gradient of an electric field intensity) between the two electrodes 9120 is largest between adjacent corner portions 9127 of the two electrodes 9120. Therefore, the dielectric particles P1 are attracted to the corner portions 9127. Hence, the dielectric particles P1 are attracted to end portions of the electrodes 9120 in the width direction. It is noted that, in the comparative separation chip 9100, even if a frequency and a voltage are changed, the positions where the dielectric particles P1 are attracted do not change.

On the other hand, as illustrated in FIG. 5, in the separation chip 100 of the present example embodiment, the thickness of the insulation film 103 on the first region 12051 of the electrode 120 is smaller than the thickness of the insulation film 103 on the second region 12052 of the electrode 120. Therefore, ∇E² between the first regions 12051 (here, the concave portions 1260) can be maximized by adjusting a voltage value and a frequency applied between the electrodes 120. Therefore, the dielectric particles P1 are attracted to the first region 12051 (here, the concave portion 1260) of the electrode 120. Hence, the dielectric particles P1 are attracted to the center of the electrode 120 in the width direction.

More specifically, the dielectrophoresis force is represented by the following general Expression (1).

$$F = 2 π {r}^{3} {ε}_{m} Re [ K ( ω ) ] ∇ {E}^{2} \qquad ( 1 )$$

Here, F represents the dielectrophoresis force. Also, r represents a radius of the dielectric particles. Also, εₘ represents a dielectric constant (real part) of a surrounding medium. Also, ω represents an angular frequency. Also, K (w) represents a Clausius-Mossotti function. Also, E represents the electric field intensity.

As can also be found from the fact that Expression (1) includes a term of ∇E², the dielectrophoresis force is generated in a non-uniform region of an AC electric field. The non-uniform region of the AC electric field indicates a region where intervals between lines of electric force change. In the comparative separation chip 9100 illustrated in FIG. 4, a non-uniform electric field is generated around the corner portions 9127 positioned at the end portions of the electrode 9120 in the width direction. Therefore, a location where the dielectric particles P1 are attracted is uniquely determined to be at the corner portions 9127. Therefore, for example, even if the frequency or the like is changed, a position where the dielectric particles P1 are attracted cannot be changed.

On the other hand, in the separation chip 100 of the present example embodiment illustrated in FIG. 5, the thickness of the insulation film 103 on the first region 12051 of the electrode 120 is made to be smaller than the thickness of the insulation film 103 on the second region 12052 of the electrode 120, so that the non-uniform region of the AC electric field on the one-side surface 1205 of the electrode 120 relatively changes with respect to the separation chip 9100. For example, by disposing the first region 12051 at any desired position, the location where the dielectric particles P1 are attracted can be set at any desired position.

Also, in the separation chip 100 of the present example embodiment, by forming the step 12053 and/or the concave portion 1260 on the one-side surface 1205 of the electrode 120, the AC electric field can be made to be more non-uniform around a predetermined position on the one-side surface 1205 of the electrode 120. That is, a rate of change in electric field intensity (gradient of the electric field intensity) around the predetermined position on the one-side surface 1205 of the electrode 120 can be further increased. Therefore, the dielectrophoresis force can be made stronger.

The separation chip 100 needs to accurately separate the specific dielectric particles P1 from the other components P2. However, due to a manufacturing error of the separation chip 100, the thickness and size of the electrode 120 and/or the insulation film 103 vary. Therefore, in order to appropriately use the separation chip 100, it is necessary to correct a voltage and/or frequency to be applied from a reference voltage and/or a reference frequency. In the case of calculating this correction value, in the present example embodiment, since the opening portion 1032 is formed in the insulation film 103, an effect of a dielectric constant of the insulation film 103 can be reduced. Therefore, the calculation can be simplified.

Also, in the separation chip 100 of the present example embodiment, by adjusting the voltage value and the frequency to be applied between the electrodes 120, the dielectric particles P1 are attracted to the center of the electrode 120 in the width direction, unlike the comparative separation chip 9100. Hence, for example, it is possible to easily determine whether or not the dielectric particles P1 are attracted to the electrode 120 due to the concave portion 1260 and/or the opening portion 1032 provided at the center of the one-side surface 1205 of the electrode 120 in the width direction.

Specifically, for example, in the case where the dielectric particles P1 were attracted to the center of the electrode 120 in the width direction, it can be found that the dielectric particles P1 were attracted due to the electric field generated in the concave portion 1260 and/or the opening portion 1032. On the other hand, in the case where the dielectric particles P1 were attracted to the end portions of the electrode 120 in the width direction, it can be found that the dielectric particles P1 were attracted to the electrode 120 regardless of the presence or absence of the concave portion 1260.

As described above, with reference to FIGS. 1 to 5, the one-side surface 1205 of the electrode 120 has the first region 12051 and the second region 12052 different from the first region 12051, and the thickness of the insulation film 103 on the first region 12051 is smaller than the thickness of the insulation film 103 on the second region 12052. Hence, a non-uniform region of the AC electric field on the one-side surface 1205 of the electrode 120 relatively changes, for example, with respect to the separation chip 9100. Therefore, for example, by disposing the first region 12051 at any desired position on the electrode 120, the location where the dielectric particles P1 are attracted can be set at any desired position.

Also, as described above, the insulation film 103 has the opening portion 1032 that allows the first region 12051 of the electrode 120 to communicate with the channel 110. Hence, the electric field intensity generated between the adjacent first regions 12051 can be increased, compared to the case where the opening portion 1032 is not formed. Therefore, the electric field intensity between the first regions 12051 can be further increased.

Also, as described above, the step 12053 is formed on the one-side surface 1205 of the electrode 120. Hence, since a more non-uniform electric field can be generated around the steps 12053 on the one-side surfaces 1205 of the electrodes 120, the dielectrophoresis force generated between the steps 12053 can be easily increased.

Also, as described above, the electrode 120 has a concave shape or a recessed shape in a cross-sectional view. Hence, for example, since the AC electric field can be made to be more non-uniform at the center of the one-side surface 1205 of the electrode 120 in the width direction, the dielectric particles P1 can be easily attracted to the center of the electrode 120 in the width direction.

Also, as described above the insulation film 103 is not formed on at least a part of the connection surface 1251. Hence, the electric field intensity generated between the connection surfaces 1251 can be increased, compared to the case where the insulation films 103 are formed on the entire connection surfaces 1251.

Also, as described above, the insulation film 103 includes a silicon oxide film or a silicon nitride film. Hence, the electrode 120 can be easily protected from the sample liquid. Also, in the case where the channel cover 105 is formed of, for example, a silicone-based resin, both the channel cover 105 and the insulation film 103 contain a silicon element, and thus the channel cover 105 can be firmly bonded to the insulation film 103.

Also, as described above, the channel cover 105 constitutes the channel 110. Hence, the dielectric particles P1 can be easily separated from the other components P2 in the sample liquid by circulating the sample liquid in the channel 110.

Also, as described above, the electrode 120 includes the first electrode 121 and the second electrode 122 which have the comb shapes opposing each other, and the plurality of teeth portions 1211 and the plurality of teeth portions 1221 extend in the second direction Y intersecting the first direction X in which the channel 110 extends. Hence, unlike the case where the plurality of teeth portions 1211 and the plurality of teeth portions 1221 are disposed to extend in the first direction X, the dielectric particles P1 contained in the sample liquid can be efficiently separated.

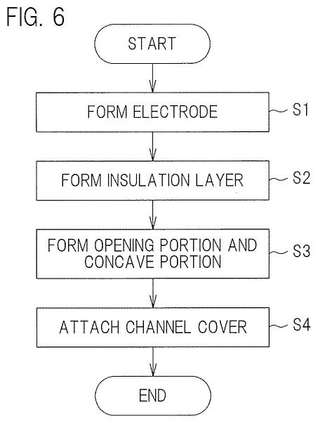

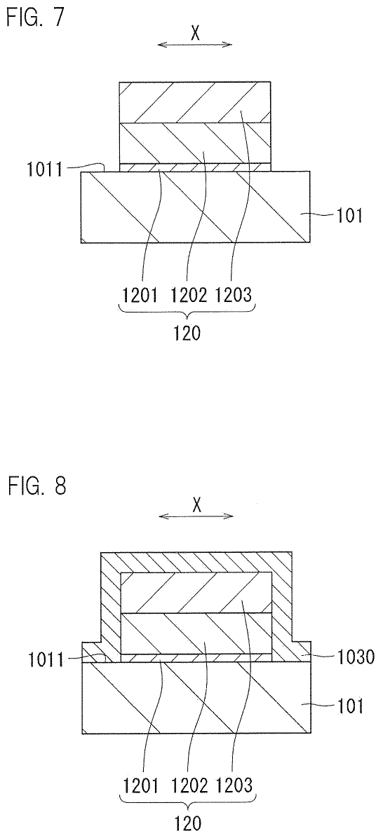

Next, a method for manufacturing the separation chip 100 of the present example embodiment will be described with reference to FIGS. 2, 3, and 6 to 8. FIG. 6 is a flowchart of the method for manufacturing the separation chip 100 of the present example embodiment. FIGS. 7 and 8 are enlarged cross-sectional views for explaining the method 1 for manufacturing the separation chip 100 of the present example embodiment. The method for manufacturing the separation chip 100 of the present example embodiment includes steps S1 to S4.

As illustrated in FIG. 6, in step S1, the electrode 120 is formed on the substrate 101. Specifically, as illustrated in FIG. 7, an electrode layer which becomes the electrode 120 is formed on the one-side surface 1011 of the substrate 101 by, for example, a vacuum deposition method. The electrode layer is patterned by, for example, a photolithography method and wet etching to form the electrode 120 having a predetermined shape. It is noted that the method of forming the electrode layer on the substrate 101 is not limited to the vacuum deposition method, and other methods such as a sputtering method may be used.

Next, in step S2, as illustrated in FIG. 8, an insulation layer 1030 is formed to cover the electrode 120. Specifically, the insulation layer 1030 which becomes the insulation film 103 is formed on the one-side surface 1011 of the substrate 101 and the electrode 120 by, for example, a sputtering method. The method of forming the insulation layer 1030 is not limited to the sputtering method, and other methods such as a vacuum deposition method may be used.

Next, in step S3, as illustrated in FIG. 3, the opening portion 1032 and the concave portion 1260 are formed. Specifically, the insulation layer 1030 and the electrode 120 are patterned by, for example, a photolithography method and wet etching to form the insulation film 103 and the electrode 120 having a predetermined shape. At this time, a region of the insulation layer 1030 which is not covered with the channel cover 105 is removed. Also, at this time, in the present example embodiment, a predetermined region (region which becomes the opening portion 1032) of the insulation layer 1030 and a predetermined region (region which becomes the concave portion 1260) of the electrode 120 are removed. Consequently, the insulation film 103 having the opening portion 1032 is formed, and the electrode 120 having the concave portion 1260 is formed.

Next, in step S4, as illustrated in FIG. 2, the channel cover 105 is attached to the substrate 101 on which the electrode 120 and the insulation film 103 are formed. Specifically, a surface of the channel cover 105 on the substrate 101 side and the surfaces of the insulation film 103 and the substrate 101 on the channel cover 105 side are subjected to plasma processing. The surfaces subjected to the plasma processing are bonded to each other. Consequently, the channel cover 105 and the insulation film 103 and/or the substrate 101 adhere to each other, and the channel cover 105 is attached to the substrate 101. At this time, the channel 110 is formed between the channel cover 105 and the substrate 101.

As described above, the separation chip 100 is manufactured.

### First Modified Example

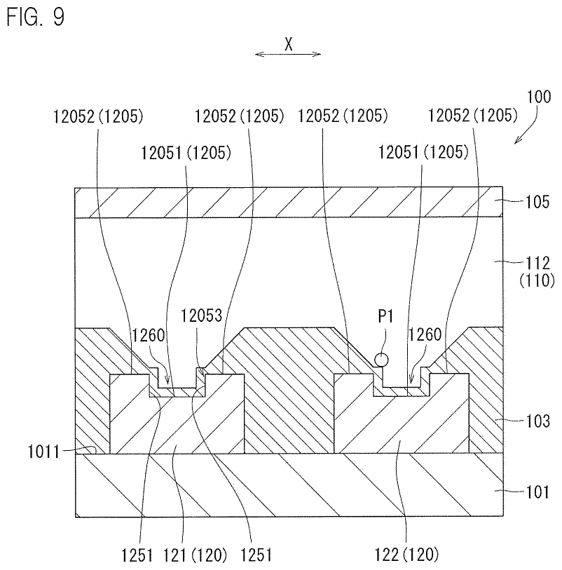

Next, a separation chip 100 according to a first modified example will be described with reference to FIG. 9. FIG. 9 is an enlarged cross-sectional view schematically showing a structure of the separation chip 100 according to the first modified example. In the first modified example, unlike the above example embodiment, an example in which the insulation film 103 is formed on the first region 12051 will be described.

As illustrated in FIG. 9, in the separation chip 100 of the first modified example, similarly to the above example embodiment, the thickness of the insulation film 103 on the first region 12051 of the electrode 120 is smaller than the thickness of the insulation film 103 on the second region 12052 of the electrode 120. Also, similarly to the above example embodiment, the step 12053 is formed on the one-side surface 1205 of the electrode 120. Also, similarly to the above example embodiment, the electrode 120 has a concave shape or a recessed shape in a cross-sectional view.

On the other hand, in the first modified example, the insulation film 103 is formed on the first region 12051. The insulation film 103 covers the entire surface of the one-side surface 1205 of the electrode 120. Also, the insulation film 103 covers the entire surface of the connection surface 1251.

The insulation film 103 is formed on the second region 12052 such that the thickness of the insulation film 103 increases outward in the width direction.

Other structures and effects of the first modified example are the same as those of the above example embodiment.

### Second Modified Example

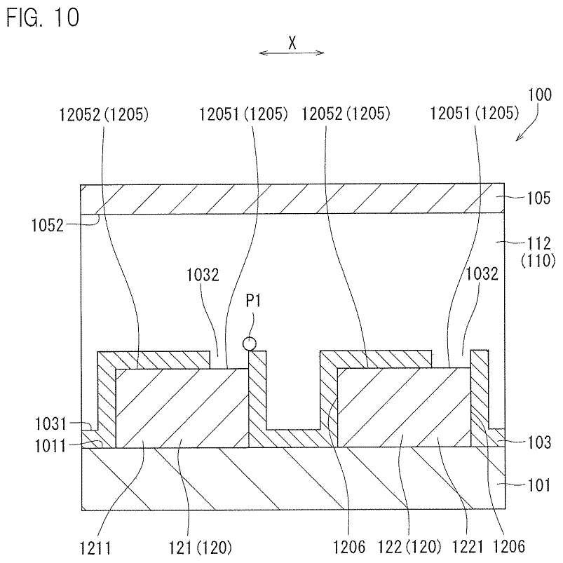

Next, a separation chip 100 according to a second modified example will be described with reference to FIG. 10. FIG. 10 is an enlarged cross-sectional view schematically showing a structure of the separation chip 100 according to the second modified example. In the second modified example, unlike the above example embodiment, an example in which the step is not formed on the one-side surface 1205 of the electrode 120 will be described.

As illustrated in FIG. 10, in the separation chip 100 of the second modified example, similarly to the above example embodiment, the thickness of the insulation film 103 on the first region 12051 of the electrode 120 is smaller than the thickness of the insulation film 103 on the second region 12052 of the electrode 120. Also, similarly to the above example embodiment, the insulation film 103 has the opening portion 1032 that allows the first region 12051 of the electrode 120 to communicate with the channel 110. That is, the insulation film 103 is not formed on the first region 12051.

On the other hand, in the second modified example, the concave portion 1260 is not formed in the electrode 120. Further, the step is not formed in the electrode 120. The electrode 120 has a substantially rectangular shape in a cross-sectional view.

In the second modified example, the opening portion 1032 is disposed at a position displaced with respect to the center of the electrode 120 in the width direction. The opening portion 1032 is formed, for example, in only one-side portion of the one-side surface 1205 of the electrode 120 in the width direction. Hence, the dielectric particles P1 can be attracted only to the one-side portion of the electrode 120 in the width direction.

Other structures and effects of the second modified example are the same as those of the above example embodiment.

### Third Modified Example

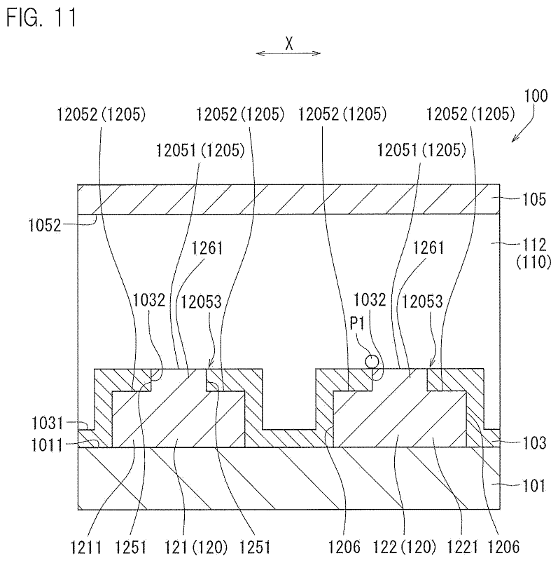

Next, a separation chip 100 according to a third modified example will be described with reference to FIG. 11. FIG. 11 is an enlarged cross-sectional view schematically showing a structure of the separation chip 100 according to the third modified example. In the third modified example, unlike the above example embodiment, an example in which the concave portion 1260 is not formed in the electrode 120 will be described.

As illustrated in FIG. 11, in the separation chip 100 of the third modified example, similarly to the above example embodiment, the thickness of the insulation film 103 on the first region 12051 of the electrode 120 is smaller than the thickness of the insulation film 103 on the second region 12052 of the electrode 120. Also, similarly to the above example embodiment, the insulation film 103 has the opening portion 1032 that allows the first region 12051 of the electrode 120 to communicate with the channel 110. Also, similarly to the above example embodiment, the step 12053 is formed on the one-side surface 1205 of the electrode 120. Also, similarly to the above example embodiment, the one-side surface 1205 has the first region 12051 positioned at the center in the width direction and a pair of second regions 12052 disposed outward in the width direction with respect to the first region 12051.

On the other hand, in the third modified example, the electrode 120 has a convex shape or a projecting shape in a cross-sectional view. Specifically, the electrode 120 has a pair of second regions 12052, a first region 12051, and a pair of connection surfaces 1251. Specifically, each of the pair of second regions 12052 extends inward in the width direction from the pair of side surfaces 1206. The first region 12051 is disposed substantially parallel to the second regions 12052 between the pair of second regions 12052. The first region 12051 is disposed at a position farther from the substrate 101 than the pair of second regions 12052 are. A projecting portion 1261 is formed on the electrode 120 by the first region 12051 and the pair of connection surfaces 1251.

Other structures and effects of the third modified example are the same as those of the above example embodiment.

### Fourth Modified Example

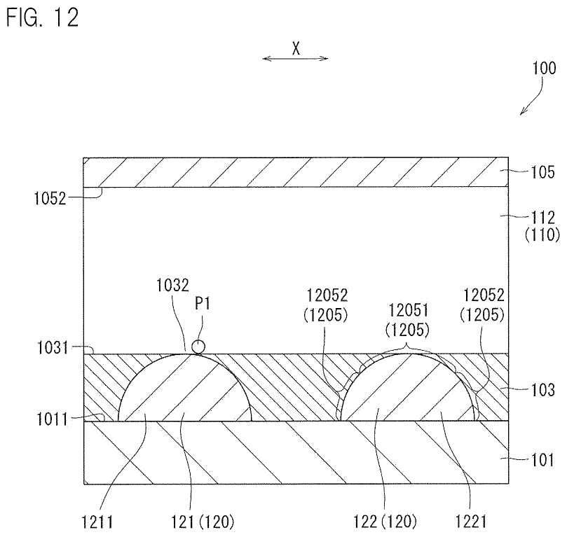

Next, a separation chip 100 according to a fourth modified example will be described with reference to FIG. 12. FIG. 12 is an enlarged cross-sectional view schematically showing a structure of the separation chip 100 according to the fourth modified example. In the fourth modified example, unlike the above example embodiment, an example in which the electrode 120 has a curved front surface will be described.

As illustrated in FIG. 12, in the separation chip 100 of the fourth modified example, similarly to the above example embodiment, the thickness of the insulation film 103 on the first region 12051 of the electrode 120 is smaller than the thickness of the insulation film 103 on the second region 12052 of the electrode 120. Also, similarly to the above example embodiment, the insulation film 103 has the opening portion 1032 that allows the first region 12051 of the electrode 120 to communicate with the channel 110. Also, similarly to the above example embodiment, the one-side surface 1205 has the first region 12051 positioned at the center in the width direction and a pair of second regions 12052 disposed outward in the width direction with respect to the first region 12051.

On the other hand, in the fourth modified example, the step 12053 is not formed on the one-side surface 1205 of the electrode 120. Specifically, the electrode 120 has a substantially semicircular shape in a cross-sectional view.

The thickness of the insulation film 103 on the first region 12051 gradually increases outward in the width direction. Also, the thickness of the insulation film 103 on the second region 12052 gradually increases outward in the width direction. The opening portion 1032 is formed in a portion of the insulation film 103 corresponding to the center of the first region 12051 in the width direction.

Other structures and effects of the fourth modified example are the same as those of the above example embodiment.

### Fifth Modified Example

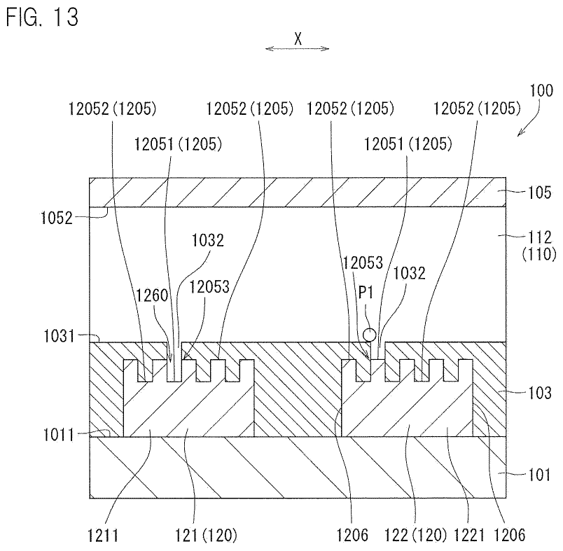

Next, a separation chip 100 according to a fifth modified example will be described with reference to FIG. 13. FIG. 13 is an enlarged cross-sectional view schematically showing a structure of the separation chip 100 according to the fifth modified example. In the fifth modified example, unlike the above example embodiment, an example in which a plurality of concave portions 1260 or recess portions are formed on the one-side surface 1205 of the electrode 120 will be described.

As illustrated in FIG. 13, in the separation chip 100 of the fifth modified example, similarly to the above example embodiment, the thickness of the insulation film 103 on the first region 12051 of the electrode 120 is smaller than the thickness of the insulation film 103 on the second region 12052 of the electrode 120. Also, similarly to the above example embodiment, the insulation film 103 has the opening portion 1032 that allows the first region 12051 of the electrode 120 to communicate with the channel 110. That is, the insulation film 103 is not formed on the first region 12051. Also, similarly to the above example embodiment, the step 12053 is formed on the one-side surface 1205 of the electrode 120. Also, similarly to the above example embodiment, the electrode 120 has a concave shape or a recessed shape in a cross-sectional view.

On the other hand, in the fifth modified example, the opening portion 1032 is disposed at a position displaced with respect to the center of the electrode 120 in the width direction. The opening portion 1032 is formed, for example, in only one-side portion of the one-side surface 1205 of the electrode 120 in the width direction.

On the other hand, in the fifth modified example, the plurality of concave portions 1260 (or recess portions) are formed in the one-side surface 1205 of the electrode 120. The opening portion 1032 may be formed in a portion of the insulation film 103 corresponding to a portion on one concave portion 1260, or may be formed in a portion of the insulation film 103 corresponding to a portion between a pair of the adjacent concave portions 1260.

Other structures and effects of the fifth modified example are the same as those of the above example embodiment and the second modified example.

### Sixth Modified Example

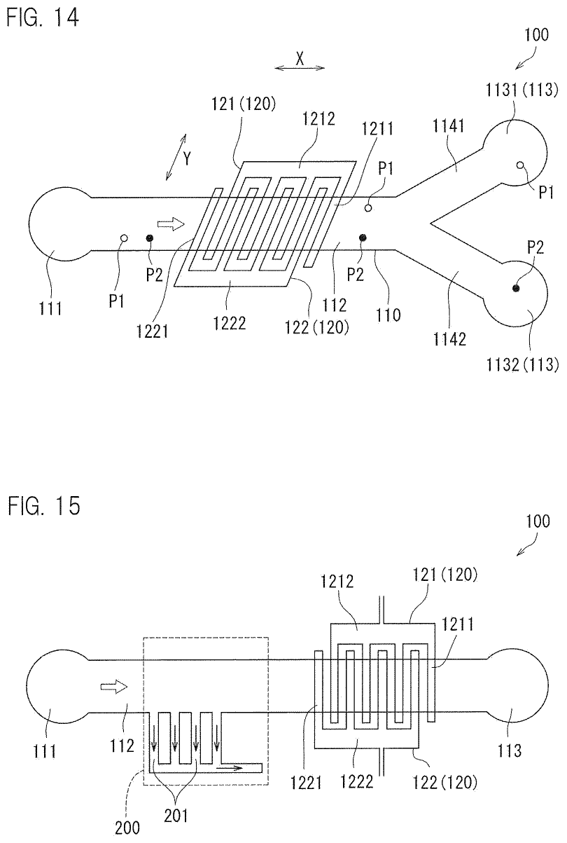

Next, a separation chip 100 according to a sixth modified example will be described with reference to FIG. 14. FIG. 14 is a plan view schematically showing a structure of the separation chip 100 according to the sixth modified example. In the sixth modified example, unlike the above example embodiment, an example in which the teeth portions 1211 and the teeth portions 1221 of the electrode 120 are inclined with respect to the channel 110 will be described.

As illustrated in FIG. 14, in the separation chip 100 of the sixth modified example, the plurality of teeth portions 1211 of the first electrode 121 and the plurality of teeth portions 1221 of the second electrode 122 extend in the second direction Y intersecting the first direction X in which the channel 110 extends. In the sixth modified example, unlike the above example embodiment, the second direction Y is inclined with respect to the first direction X. That is, in the sixth modified example, the teeth portions 1211 and the teeth portions 1221 are inclined with respect to the channel 110. With such a configuration, for example, by applying an AC voltage of a specific frequency between the first electrode 121 and the second electrode 122, the dielectric particles P1 can be moved along the teeth portions 1211 and the teeth portions 1221. Therefore, the dielectric particles P1 can be separated from the other components P2. Details will be described below.

In the sixth modified example, the collection portion 113 of the channel 110 includes a first collection portion 1131 and a second collection portion 1132. The first collection portion 1131 collects the dielectric particles P1. The second collection portion 1132 collects the other components P2. The channel 110 further includes a first connection channel 1141 and a second connection channel 1142. The first connection channel 1141 connects a downstream portion of the separation channel 112 and the first collection portion 1131 to each other. The second connection channel 1142 connects a downstream portion of the separation channel 112 and the second collection portion 1132 to each other.

In the separation chip 100 of the sixth modified example, by applying an AC voltage of a specific frequency between the first electrode 121 and the second electrode 122, a dielectrophoresis force acts on the dielectric particles P1 passing through the separation channel 112. Consequently, the dielectric particles P1 move along the teeth portions 1211 and the teeth portions 1221. In the sixth modified example, the dielectric particles P1 move toward the first connection portion 1212 along the teeth portions 1211 and the teeth portions 1221. It is noted that, in the sixth modified example, the frequency of the AC voltage is set so that the dielectric particles P1 are not captured by the electrode 120.

The dielectric particles P1 pass through the first connection channel 1141 and are collected in the first collection portion 1131. On the other hand, the other components P2 travel straight through the separation channel 112, pass through the second connection channel 1142, and are collected in the second collection portion 1132.

Other structures, manufacturing methods, and effects of the sixth modified example are the same as those of the above example embodiment.

### Seventh Modified Example

Next, a separation chip 100 according to a seventh modified example will be described with reference to FIG. 15. FIG. 15 is a plan view schematically showing a structure of the separation chip 100 according to the seventh modified example. In the seventh modified example, unlike the above example embodiment, an example in which the separation chip 100 includes, for example, a hydrodynamic filtration (HDF) 200 will be described.

As illustrated in FIG. 15, in the seventh modified example, the separation chip 100 further includes the HDF 200. The HDF 200 is disposed upstream of the electrode 120. The HDF 200 functions as a hydrodynamic filter. For example, the HDF 200 is microchannels for the purpose of separating and concentrating fine particles. The HDF 200 has a plurality of branch channels 201 branching from the separation channel 112. The plurality of branch channels 201 and a part of the separation channel 112 constitute the HDF 200. The plurality of branch channels 201 are disposed, for example, to extend perpendicularly to the separation channel 112. The plurality of branch channels 201 are disposed at substantially equal pitches in the extending direction of the separation channel 112, for example.

A liquid flowing through the separation channel 112 partially flows into the plurality of branch channels 201. Some of the particles contained in the liquid flowing through the separation channel 112 flow into the plurality of branch channels 201. Specifically, particles having a particle size smaller than a predetermined size are to flow into the branch channels 201, and particles having a particle size larger than the predetermined size are not to flow into the branch channels 201 but to flow substantially straight through the separation channel 112. That is, the HDF 200 separates particles having a particle size smaller than the predetermined size from the liquid flowing through the separation channel 112. In the seventh modified example, the dielectric particles P1 do not flow into the branch channels 201 of the HDF 200, and travel substantially straight through the separation channel 112.

In the seventh modified example, as described above, the separation chip 100 further includes the HDF 200. Hence, the HDF 200 can separate particles having a size smaller than the predetermined size from the particles contained in the sample liquid, and then the electrode 120 can separate the dielectric particles P1 from the particles having the predetermined size or larger.

Other structures, manufacturing methods, and effects of the seventh modified example are the same as those of the above example embodiment.

The example embodiment of the present invention has been described above with reference to the drawings. However, the present invention is not limited to the above example embodiment, and can be implemented in various modes without departing from the gist thereof. Also, various inventions can be formed by appropriately combining a plurality of constituent elements disclosed in the above example embodiment. For example, some constituent elements may be removed from all of the constituent elements illustrated in the example embodiment. Further, the constituent elements of different example embodiments and modified examples may be appropriately combined. For an easy understanding, the drawings schematically illustrate individual constituent elements as main elements, and a thickness, a length, the number of, intervals, and the like of illustrated individual constituent elements may be different from the actual thickness, length, number of, interval, and the like for convenience of making the drawings. Also, the material, shape, dimension, and the like of each constituent element illustrated in the above example embodiment are merely examples, and are not particularly limited, and various modifications can be made without substantially departing from the effects of the present invention.

For example, in the above example embodiment, the example in which the electrode 120 includes the first layer 1201, the second layer 1202, and the third layer 1203 has been described, but the present invention is not limited thereto. For example, the electrode 120 may include one layer, two layers, or four or more layers.

Also, in the above example embodiment, the example in which the first electrode 121 and the second electrode 122 have the comb shapes has been described, but the present invention is not limited thereto. For example, the first electrode 121 and the second electrode 122 may not have the comb shapes.

Also, in the above example embodiment, the example in which the sample liquid flows in the channel 110 has been described, but the present invention is not limited thereto. That is, an example in which the introduction portion is the channel 110 in which the sample liquid flows has been described, but the present invention is not limited thereto. For example, the introduction portion may be a storage portion in which the sample liquid is stored. In this case, the introduction-portion constituting member may have only the side wall without having the ceiling.

Also, in the above example embodiment, the example in which the predetermined region of the insulation film 103 and the predetermined region of the electrode 120 are removed in one step (step S3) has been described, but the present invention is not limited thereto. For example, after the electrode 120 is formed in a predetermined shape and the insulation film 103 is formed to cover the electrode 120, only a predetermined region of the insulation film 103 may be removed. For example, a manufacturing flow may be appropriately changed according to the shape of the electrode 120 and/or the shape of the insulation film 103, etc., illustrated in FIGS. 9 to 13.

Also, for example, in the above example embodiment, the first modified example, the third modified example, and/or the fourth modified example, the concave portion 1260, the opening portion 1032, and/or the projecting portion 1261 may be formed at a position displaced with respect to the center of the electrode 120 in the width direction.

Although the example embodiment of the present invention has been described in detail, these are merely specific examples used to clarify the technical contents of the present invention, and the present invention should not be construed as limited to these specific examples, and the scope of the present invention is limited only by the accompanying claims.

What is claimed is:

1. A separation chip comprising:
a substrate;
a plurality of electrodes disposed on one-side surface of the substrate;
an insulation film covering at least a part of one-side surface of each of the electrodes; and
an introduction-portion constituting member that is disposed on one side of the substrate, surrounds at least a portion of the electrodes, and defines an introduction portion into which a liquid containing dielectric particles is introduced, wherein
the one-side surface of each of the electrodes has a first region and a second region different from the first region, and
a thickness of the insulation film on the first region is smaller than a thickness of the insulation film on the second region.

2. The separation chip according to claim 1, wherein the insulation film has an opening portion allowing the first region of each of the electrodes to communicate with the introduction portion.

3. The separation chip according to claim 2, wherein the opening portion is formed at a position displaced with respect to a center of each of the electrodes in a width direction.

4. The separation chip according to claim 1, wherein a step is formed on the one-side surface of each of the electrodes.

5. The separation chip according to claim 4, wherein each of the electrodes has a concave shape in a cross-sectional view.

6. The separation chip according to claim 5, wherein
each of the electrodes includes
a pair of side surfaces disposed at end portions in a width direction, and
a pair of connection surfaces,
the second regions are provided as a pair,
each of the pair of second regions extends inward in the width direction from the pair of side surfaces,
the first region is disposed substantially parallel to the second regions between the pair of second regions,
the pair of connection surfaces connect the pair of second regions and the first region to each other, and
the insulation film is not formed on at least a part of the pair of connection surfaces.

7. The separation chip according to claim 1, wherein the insulation film includes a silicon oxide film or a silicon nitride film.

8. The separation chip according to claim 1, wherein
the introduction portion includes a channel through which the liquid flows, and
the introduction-portion constituting member defines the channel.

9. The separation chip according to claim 8, wherein
the plurality of electrodes includes a first electrode and a second electrode which have comb shapes opposing each other,
each of the first electrode and the second electrode has a plurality of teeth portions disposed in parallel to each other,
one-side surface of each of the teeth portions has the first region and the second region, and
the plurality of teeth portions extend in an intersecting direction intersecting an extending direction of the channel.
